(19) United States
(12) Patent Application Publication
(10) Pub. No.: US 2019/0380028 A1
(43) Pub. Date: Dec. 12, 2019

(54) USER EQUIPMENT IDENTITY IMPLEMENTATION IN MOBILE EDGE SCENARIOS

(71) Applicant: NOKIA TECHNOLOGIES OY, Espoo (FI)

(72) Inventor: John Juha Antero RASANEN, Espoo (FI)

(21) Appl. No.: 16/463,177

(22) PCT Filed: Nov. 22, 2016
(86) PCT No.: PCT/EP2016/078405

§ 371 Date: May 22, 2019

(51) Int. Cl. H04W 12/02; H04W 12/00; H04W 8/26; H04W 8/08

(52) U.S. Cl. CPC H04W 12/02; H04W 8/08; H04W 8/26; H04W 12/00514

(57) ABSTRACT

User equipment identity implementation in mobile edge scenarios There are provided measures for user equipment identity implementation in mobile edge scenarios. Such measures (in a mobile edge platform entity in a mobile edge computing server of a first network, the mobile edge computing server comprising at least said mobile edge platform entity and a mobile edge computing application entity) exemplarily comprise obtaining a conjunction of a common identifier of a network communication participant and a network address assigned to said network communication participant in said first network, wherein said common identifier is common to said first network and a second network, receiving, from said mobile edge computing application entity, a request to register a token for said network communication participant, wherein said request comprises at least said common identifier and said token, and generating an action rule for said network communication participant on the basis of said request.

### FIELD

The present invention relates to user equipment identity implementation in mobile edge scenarios. More specifically, the present invention exemplarily relates to measures (including methods, apparatuses and computer program products) for realizing user equipment identity implementation in mobile edge scenarios.

### BACKGROUND

The present specification generally relates to routing by private identities feature in mobile edge scenarios.

The European Telecommunications Standards Institute (ETSI) Industry Specification Group (ISG) for Mobile Edge Computing (MEC), i.e., “ETSI ISG MEC”, is concerned with standardizing MEC. According to work item “UE Identity” of the ETSI ISG MEC, a MEC application is supposed to provide the Mobile Edge Platform with a token or tokens, i.e., a user identity or user identities, representing a terminal, e.g. a user equipment (UE), and belonging to the realm of a local network, e.g. an enterprise network.

The Mobile Edge Platform is supposed to use the token(s) for creating filters for routing related traffic of the UE to the local network. The filters are supposed to be activated on a data/forwarding plane of a MEC server.

This routing related feature is called “routing-by-private-identities feature”.

Throughout this specification, if not otherwise defined, the term “MEC application” means a MEC application (i.e. MEC application entity) handling the above outlined private identity procedures.

FIG. 7 is a block diagram illustrating an exemplary operating environment according to the ETSI MEC UE Identity application programming interface (API) work item and a simplified architecture of a MEC server 73 with parts/entities essential for the description in the present specification.

In particular, such MEC server 73 comprises a Mobile Edge (ME) platform (mobile edge platform entity) 73b, a data/forwarding plane (data forwarding plane entity) 73c, and MEC applications 73a, wherein the token providing application (i.e. the MEC application entity handling the above outlined private identity procedures) being one of the applications of the MEC server 73.

According to the exemplary operating environment, a UE 71 is connected via an evolved Node B (eNodeB, eNB) 72 with the MEC server 73, which in turn may be connected to a mobile core network 74 and an enterprise/private local area network (LAN) 75. The mobile core network 74 may for example comprise a mobility management entity (MME) 74a and a gateway (GW) 74b as well as further entities.

The above-mentioned supposedly created routing filters cannot be based purely on the private user identities (tokens), because that would mean that a traffic detection function on the data plane would have to monitor every data flow of every user/UE flowing through the data plane and check against all private identities/tokens of all users. Moreover, basing the routing filters only on such private user identities (tokens) would give an opportunity for a fraudulent user/UE (having another internet protocol (IP) address) to steal the private identity of another user and get an access into the private network.

Hence, it is preferable that certain private identities are monitored only in the data flows of the right/given user/UE identified by mobile network internal means, which is an international mobile subscriber identity (IMSI) and UE IP address pair.

A user/UE attaching to the network is identified by its IMSI, and the network allocates an IP address to the UE. After that, all data flows of the UE can be identified by the IP address of the UE.

Consequently, the data/forwarding plane needs the IP address of the UE whose data flows are to be monitored for possible private identities and related routing actions in order to implement respective routing actions.

The IP address of the UE is known by the core network (e.g. MME). The private network identities, however, do not have any relationship with the IP address allocated by the mobile core network to the UE. On the other hand, the private network does not know the IMSI of the user/UE, because IMSI is a mobile network internal identity.

Hence, the problem arises that there is no way to bind the private identities of the private network to the current IP address of the user/UE. Accordingly, the above-outlined “routing-by-private-identities” feature cannot be deployed.

Hence, there is a need to provide for user equipment identity implementation in mobile edge scenarios.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method of a mobile edge computing application entity in a mobile edge computing server of a first network, the mobile edge computing server comprising at least said mobile edge computing application entity and a mobile edge platform entity, said method comprising receiving a conjunction of a common identifier of a network communication participant and a network specific identifier of said network communication participant in a second network, wherein said common identifier is common to said first network and said second network, receiving a trigger to register a token for said network communication participant, wherein said trigger comprises at least said token and one of said common identifier and said network specific identifier of said network communication participant in said second network, and transmitting, to said mobile edge platform entity, a request to register said token for said network communication participant, wherein said request comprises at least said common identifier and said token.

According to an exemplary aspect of the present invention, there is provided a method of a mobile edge platform entity in a mobile edge computing server of a first network, the mobile edge computing server comprising at least said mobile edge platform entity and a mobile edge computing application entity, said method comprising obtaining a conjunction of a common identifier of a network communication participant and a network address assigned to said network communication participant in said first network, wherein said common identifier is common to said first network and a second network, receiving, from said mobile edge computing application entity, a request to register a token for said network communication participant, wherein said request comprises at least said common identifier and said token, and generating an action rule for said network communication participant on the basis of said request.

According to an exemplary aspect of the present invention, there is provided an apparatus of a mobile edge computing application entity in a mobile edge computing server of a first network, the mobile edge computing server comprising at least said mobile edge computing application entity and a mobile edge platform entity, the apparatus comprising at least one processor, at least one memory including computer program code, and at least one interface configured for communication with at least another apparatus, the at least one processor, with the at least one memory and the computer program code, being configured to cause the apparatus to perform receiving a conjunction of a common identifier of a network communication participant and a network specific identifier of said network communication participant in a second network, wherein said common identifier is common to said first network and said second network, receiving a trigger to register a token for said network communication participant, wherein said trigger comprises at least said token and one of said common identifier and said network specific identifier of said network communication participant in said second network, and transmitting, to said mobile edge platform entity, a request to register said token for said network communication participant, wherein said request comprises at least said common identifier and said token.

According to an exemplary aspect of the present invention, there is provided an apparatus of a mobile edge platform entity in a mobile edge computing server of a first network, the mobile edge computing server comprising at least said mobile edge platform entity and a mobile edge computing application entity, the apparatus comprising at least one processor, at least one memory including computer program code, and at least one interface configured for communication with at least another apparatus, the at least one processor, with the at least one memory and the computer program code, being configured to cause the apparatus to perform obtaining a conjunction of a common identifier of a network communication participant and a network address assigned to said network communication participant in said first network, wherein said common identifier is common to said first network and a second network, receiving, from said mobile edge computing application entity, a request to register a token for said network communication participant, wherein said request comprises at least said common identifier and said token, and generating an action rule for said network communication participant on the basis of said request.

According to an exemplary aspect of the present invention, there is provided an apparatus of a mobile edge computing application entity in a mobile edge computing server of a first network, the mobile edge computing server comprising at least said mobile edge computing application entity and a mobile edge platform entity, the apparatus comprising receiving circuitry configured to receive a conjunction of a common identifier of a network communication participant and a network specific identifier of said network communication participant in a second network, wherein said common identifier is common to said first network and said second network, and to receive a trigger to register a token for said network communication participant, wherein said trigger comprises at least said token and one of said common identifier and said network specific identifier of said network communication participant in said second network, and transmitting circuitry configured to transmit, to said mobile edge platform entity, a request to register said token for said network communication participant, wherein said request comprises at least said common identifier and said token.

According to an exemplary aspect of the present invention, there is provided an apparatus of a mobile edge platform entity in a mobile edge computing server of a first network, the mobile edge computing server comprising at least said mobile edge platform entity and a mobile edge computing application entity, the apparatus comprising obtaining circuitry configured to obtain a conjunction of a common identifier of a network communication participant and a network address assigned to said network communication participant in said first network, wherein said common identifier is common to said first network and a second network, receiving circuitry configured to receive, from said mobile edge computing application entity, a request to register a token for said network communication participant, wherein said request comprises at least said common identifier and said token, and generating circuitry configured to generate an action rule for said network communication participant on the basis of said request.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient joining of several identities of network elements (more general, of network communication participants) to thereby solve at least part of the problems and drawbacks identified in relation to the prior art.

By way of exemplary embodiments of the present invention, there is provided user equipment identity implementation in mobile edge scenarios. More specifically, by way of exemplary embodiments of the present invention, there are provided measures and mechanisms for realizing user equipment identity implementation in mobile edge scenarios.

Thus, improvement is achieved by methods, apparatuses and computer program products enabling/realizing user equipment identity implementation in mobile edge scenarios.

### BRIEF DESCRIPTION OF THE DRAWINGS

In the following, the present invention will be described in greater detail by way of non-limiting examples with reference to the accompanying drawings, in which

FIG. 1 is a block diagram illustrating an apparatus according to exemplary embodiments of the present invention,

FIG. 2 is a block diagram illustrating an apparatus according to exemplary embodiments of the present invention,

FIG. 3 is a block diagram illustrating an apparatus according to exemplary embodiments of the present invention,

FIG. 4 is a block diagram illustrating an apparatus according to exemplary embodiments of the present invention,

FIG. 5 is a schematic diagram of a procedure according to exemplary embodiments of the present invention,

FIG. 6 is a schematic diagram of a procedure according to exemplary embodiments of the present invention,

FIG. 7 is a block diagram illustrating an exemplary operating environment according to exemplary embodiments of the present invention,

FIG. 8 shows a schematic diagram of an example of a system environment with signaling variants according to exemplary embodiments of the present invention,

FIG. 9 shows a schematic diagram of an example of a system environment with signaling variants according to exemplary embodiments of the present invention, and

FIG. 10 is a block diagram alternatively illustrating apparatuses according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to radio networks and in particular to 3^{rd} Generation Partnership Project (3GPP) specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment (in particular including wired networks and network technologies differing from 3GPP specifications), etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) user equipment identity implementation in mobile edge scenarios.

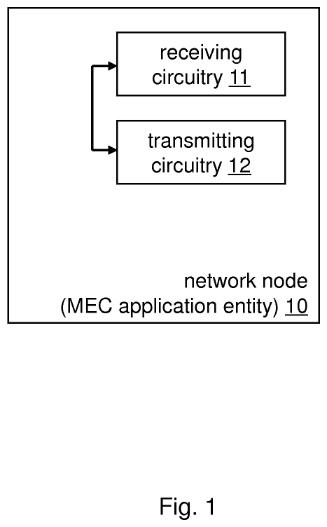

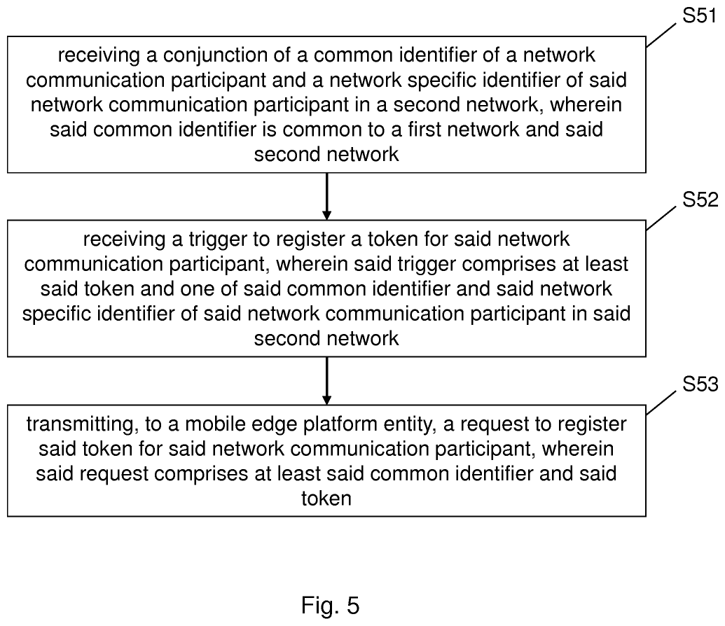

FIG. 1 is a block diagram illustrating an apparatus according to exemplary embodiments of the present invention. The apparatus may be a network node 10 such as a mobile edge computing application entity (e.g. in a mobile edge computing server of a first network, the mobile edge computing server comprising at least said mobile edge computing application entity and a mobile edge platform entity) comprising a receiving circuitry 11 and a transmitting circuitry 12. The receiving circuitry 11 receives a conjunction of a common identifier of a network communication participant and a network specific identifier of said network communication participant in a second network, wherein said common identifier is common to said first network and said second network. The receiving circuitry 11 further receives a trigger to register a token for said network communication participant, wherein said trigger comprises at least said token and one of said common identifier and said network specific identifier of said network communication participant in said second network. The transmitting circuitry 12 transmits, to said mobile edge platform entity, a request to register said token for said network communication participant, wherein said request comprises at least said common identifier and said token. FIG. 5 is a schematic diagram of a procedure according to exemplary embodiments of the present invention. The apparatus according to FIG. 1 may perform the method of FIG. 5 but is not limited to this method. The method of FIG. 5 may be performed by the apparatus of FIG. 1 but is not limited to being performed by this apparatus.

As shown in FIG. 5, a procedure according to exemplary embodiments of the present invention comprises an operation of receiving (S51) a conjunction of a common identifier of a network communication participant and a network specific identifier of said network communication participant in a second network, wherein said common identifier is common to said first network and said second network, an operation of receiving (S52) a trigger to register a token for said network communication participant, wherein said trigger comprises at least said token and one of said common identifier and said network specific identifier of said network communication participant in said second network, and an operation of transmitting (S53), to said mobile edge platform entity, a request to register said token for said network communication participant, wherein said request comprises at least said common identifier and said token.

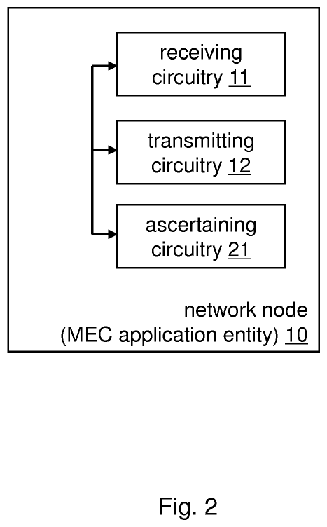

FIG. 2 is a block diagram illustrating an apparatus according to exemplary embodiments of the present invention. In particular, FIG. 2 illustrates a variation of the apparatus shown in FIG. 1. The apparatus according to FIG. 2 may thus further comprise an ascertaining circuitry 21.

In an embodiment at least some of the functionalities of the apparatus shown in FIGS. 1 (and 2) may be shared between at least two physically separate devices forming one operational entity. Therefore, the apparatus may be seen to depict the operational entity comprising one or more physically separate devices for executing at least some of the described processes.

According to a variation of the procedure shown in FIG. 5, exemplary details of the transmitting operation (S53) are given, which are inherently independent of each other as such.

Such exemplary transmitting operation (S53) according to exemplary embodiments of the present invention may comprise an operation of, if said trigger comprises said network specific identifier of said network communication participant in said second network, ascertaining said common identifier based on said conjunction and said network specific identifier of said network communication participant in said second network included in said trigger.

According to exemplary embodiments of the present invention, said conjunction is received from said network communication participant or a control entity of said second network.

According to further exemplary embodiments of the present invention, said trigger is received from said network communication participant or said control entity of said second network.

According to still further exemplary embodiments of the present invention, at least one of said first network and said second network is a radio network.

According to still further exemplary embodiments of the present invention, said first network is one of a LTE cellular network system, a LTE-A cellular network system, and a 5G network system.

According to still further exemplary embodiments of the present invention, said second network is one of a private network, an enterprise network, and a local area network.

According to still further exemplary embodiments of the present invention, said network communication participant is a terminal and said common identifier is a device identifier globally unique to said terminal.

According to still further exemplary embodiments of the present invention, said network communication participant is a subscriber utilizing a terminal and said common identifier is a subscriber identifier globally unique to said subscriber.

According to still further exemplary embodiments of the present invention, said network specific identifier of said network communication participant in said second network is a user's identity in a local area network.

According to still further exemplary embodiments of the present invention, said network specific identifier of said network communication participant in said first network is an international mobile subscriber identity.

According to still further exemplary embodiments of the present invention, said token is a private identity belonging to a realm of said second network.

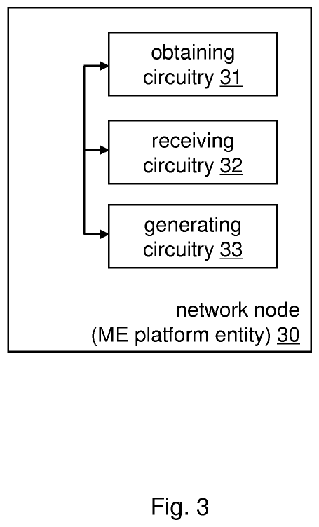

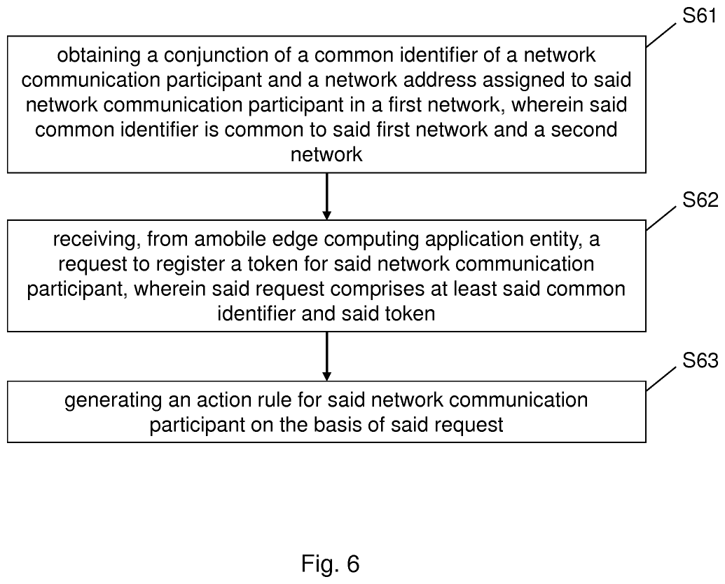

FIG. 3 is a block diagram illustrating an apparatus according to exemplary embodiments of the present invention. The apparatus may be a network node 30 such as a mobile edge platform entity (e.g. in a mobile edge computing server of a first network, the mobile edge computing server comprising at least said mobile edge platform entity and a mobile edge computing application entity) comprising an obtaining circuitry 31, a receiving circuitry 32, and a generating circuitry 33. The obtaining circuitry 31 obtains a conjunction of a common identifier of a network communication participant and a network address assigned to said network communication participant in said first network, wherein said common identifier is common to said first network and a second network. The receiving circuitry 32 receives, from said mobile edge computing application entity, a request to register a token for said network communication participant, wherein said request comprises at least said common identifier and said token. The generating circuitry 33 generates an action rule for said network communication participant on the basis of said request. FIG. 6 is a schematic diagram of a procedure according to exemplary embodiments of the present invention. The apparatus according to FIG. 3 may perform the method of FIG. 6 but is not limited to this method. The method of FIG. 6 may be performed by the apparatus of FIG. 3 but is not limited to being performed by this apparatus.

As shown in FIG. 6, a procedure according to exemplary embodiments of the present invention comprises an operation of obtaining (S61) a conjunction of a common identifier of a network communication participant and a network address assigned to said network communication participant in said first network, wherein said common identifier is common to said first network and a second network, an operation of receiving (S62), from said mobile edge computing application entity, a request to register a token for said network communication participant, wherein said request comprises at least said common identifier and said token, and an operation of generating (S63) an action rule for said network communication participant on the basis of said request.

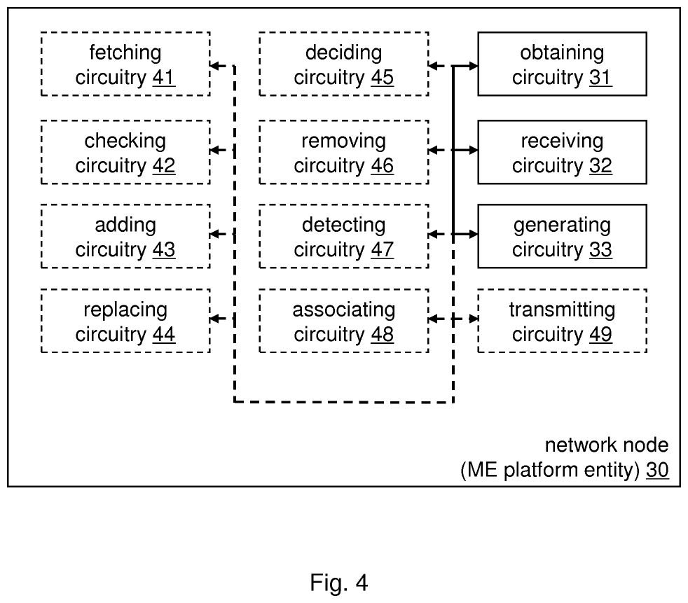

FIG. 4 is a block diagram illustrating an apparatus according to exemplary embodiments of the present invention. In particular, FIG. 4 illustrates a variation of the apparatus shown in FIG. 3. The apparatus according to FIG. 4 may thus further comprise a fetching circuitry 41, a checking circuitry 42, an adding circuitry 43, a replacing circuitry 44, a deciding circuitry 45, a removing circuitry 46, a detecting circuitry 47, an associating circuitry 48, and(or a transmitting circuitry 49.

In an embodiment at least some of the functionalities of the apparatus shown in FIGS. 3 (and 4) may be shared between at least two physically separate devices forming one operational entity. Therefore, the apparatus may be seen to depict the operational entity comprising one or more physically separate devices for executing at least some of the described processes.

According to a variation of the procedure shown in FIG. 6, exemplary details of the obtaining operation (S61) are given, which are inherently independent of each other as such.

Such exemplary obtaining operation (S61) according to exemplary embodiments of the present invention may comprise an operation of receiving said conjunction from a core network entity of said first network.

According to exemplary embodiments of the present invention, said conjunction further comprises a network specific identifier of said network communication participant in said first network.

According to a variation of the procedure shown in FIG. 6, exemplary details of the obtaining operation (S61) are given, which are inherently independent of each other as such.

Such exemplary obtaining operation (S61) according to exemplary embodiments of the present invention may comprise an operation of fetching said conjunction from a storage area common with a core network entity of said first network based on said common identifier included in said request.

According to exemplary embodiments of the present invention, said conjunction further comprises a network specific identifier of said network communication participant in said first network.

According to a variation of the procedure shown in FIG. 6, exemplary details of the obtaining operation (S61) are given, which are inherently independent of each other as such.

Such exemplary obtaining operation (S61) according to exemplary embodiments of the present invention may comprise an operation of checking for existence of an entry of said network specific identifier of said network communication participant in said first network according to the conjunction, and, if said entry exists, an operation of adding said network address to said existing entry.

According to a variation of the procedure shown in FIG. 6, exemplary details of the obtaining operation (S61) are given, which are inherently independent of each other as such.

Such exemplary obtaining operation (S61) according to exemplary embodiments of the present invention may comprise an operation of, if a common identifier included in said existing entry does not correspond to said common identifier according to the conjunction and a request to replace said common identifier included in said existing entry is received, replacing said common identifier included in said existing entry by said common identifier according to the conjunction.

According to a variation of the procedure shown in FIG. 6, exemplary additional operations are given, which are inherently independent of each other as such. According to such variation, an exemplary method according to exemplary embodiments of the present invention may comprise an operation of deciding necessity to remove said conjunction, and an operation of removing, based on a result of said deciding, said conjunction from said storage area common with said core network entity and/or a storage area of said mobile edge platform entity.

Such exemplary deciding operation according to exemplary embodiments of the present invention may comprise an operation of receiving a request to remove said conjunction.

Such exemplary deciding operation according to exemplary embodiments of the present invention may in addition or alternatively comprise an operation of detecting expiration of a validity timer assigned to said conjunction.

According to a variation of the procedure shown in FIG. 6, exemplary details of the generating operation (S63) are given, which are inherently independent of each other as such.

Such exemplary generating operation (S63) according to exemplary embodiments of the present invention may comprise an operation of associating said network address with said token based on said conjunction and said common identifier included in said request.

According to further exemplary embodiments of the present invention, said action rule for said network communication participant is generated on the basis of said association of said network address and said token.

According to a variation of the procedure shown in FIG. 6, exemplary additional operations are given, which are inherently independent of each other as such. According to such variation, an exemplary method according to exemplary embodiments of the present invention may comprise an operation of transmitting said action rule to a rules enforcement entity of said mobile edge computing server.

According to still further exemplary embodiments of the present invention, at least one of said first network and said second network is a radio network.

According to still further exemplary embodiments of the present invention, said first network is one of a LTE cellular network system, a LTE-A cellular network system, and a 5G network system.

According to still further exemplary embodiments of the present invention, said second network is one of a private network, an enterprise network, and a local area network.

According to still further exemplary embodiments of the present invention, said network communication participant is a terminal and said common identifier is a device identifier globally unique to said terminal.

According to still further exemplary embodiments of the present invention, said network communication participant is a subscriber utilizing a terminal and said common identifier is a subscriber identifier globally unique to said subscriber.

According to still further exemplary embodiments of the present invention, said network specific identifier of said network communication participant in said second network is a user's identity in a local area network.

According to still further exemplary embodiments of the present invention, said network specific identifier of said network communication participant in said first network is an international mobile subscriber identity.

According to still further exemplary embodiments of the present invention, said token is a private identity belonging to a realm of said second network.

According to still further exemplary embodiments of the present invention, said action rule is a network traffic routing rule.

According to still further exemplary embodiments of the present invention, said rules enforcement entity is a data forwarding plane entity.

Exemplary embodiments described above are in the following explained in more specific terms.

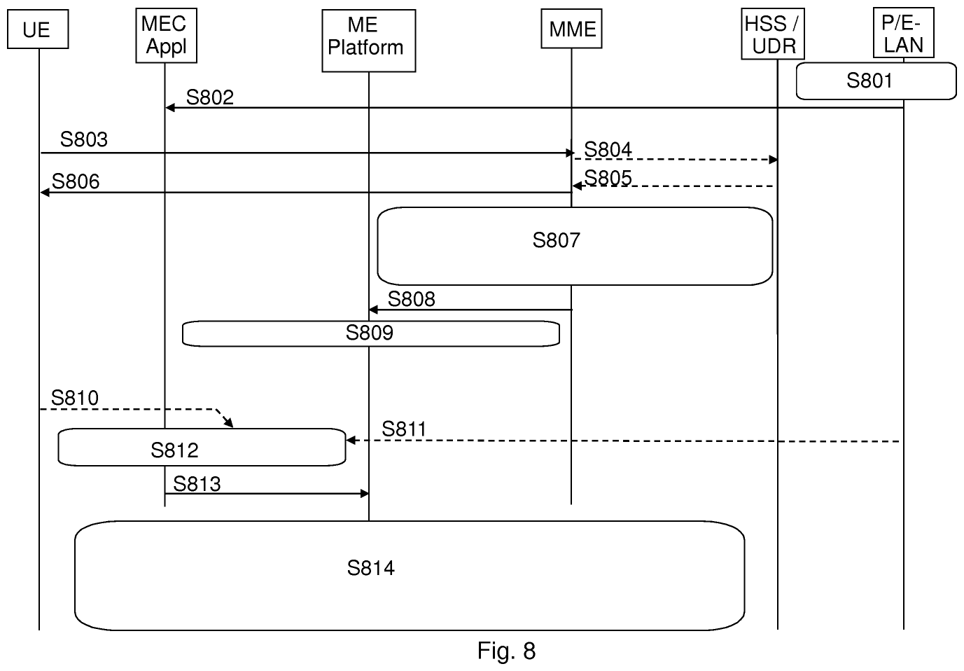

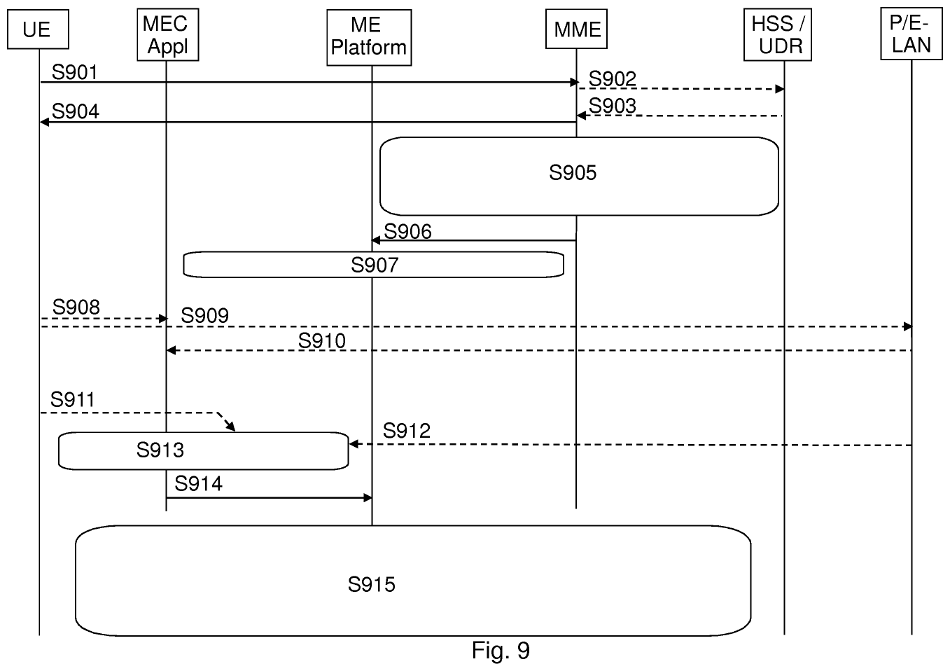

Here, FIGS. 8 and 9 show respective schematic diagrams of examples of a system environment with signaling variants according to exemplary embodiments of the present invention. These are discussed in more detail below.

According to exemplary embodiments of the present invention, a network or domain A (e.g. a private/enterprise network 75) and network or domain B (e.g. a mobile network 74) that have their own ID(s) (i.e. network/domain specific ID(s)) for a subscriber/user, are provided with a common ID for the user. After that, each network/domain knows the user by the common ID and by the network/domain specific ID.

According to exemplary embodiments, at least one subscriber related parameter (e.g. IP address, IMSI) related to an inter-network/domain operation is stored in a network/domain (e.g. network B) and made accessible/addressable by the common ID (i.e., association between the common ID and e.g. the IP address, IMSI), when the common ID is registered/activated in this network/domain (e.g. network B).

Further, an inter-network/domain related operation (e.g. registration of a token) is triggered by one network/domain (e.g. network A) in the other network/domain (e.g. network B). The common ID is used for binding the triggering input to the particular subscriber/user and to the subscriber and operation related information (e.g. the IP address, IMSI) stored in the other network/domain (e.g. network B).

Furthermore, an entity (e.g. ME platform entity 73b) in the triggered network/domain (e.g. network B) fetches the subscriber and operation related information (e.g. the IP address, IMSI) using the common ID as a key, and prepares action rule(s) requested in the triggering input, using the fetched parameter(s) in creating the rules.

Finally, the rule(s) creating entity (e.g. ME platform entity 73b) sends the action rule(s) to another entity (e.g. data forwarding plane entity 73c) for enforcement.

In more detail, if a user is or becomes a subscriber to a private/enterprise network/LAN and wants to use the routing-by-private-identities feature, one of his/her IDs is made common both to the mobile network and private/enterprise network/LAN. As an example, in the following a device ID/IMEI is used as such a common ID. However, the common ID is not limited to such device ID (and in general it could be some other ID). A benefit of using a device ID is that every device has such an ID and that device ID is typically sent to the network when the device contacts the network.

The device ID/IMEI may be registered in the LAN in different ways. Namely, according to exemplary embodiments of the present invention, the device ID/IMEI may be provided by a UE that contacts a control entity in the private/enterprise network/LAN or the MEC application (as suggested in FIG. 9, steps 908, 909), or it may simply be manually configured for each subscriber (as suggested in FIG. 8, step 801). After registration, the device ID is bound to the identity of the user known by the private/enterprise network/LAN (named “User's ID in LAN” in relation to FIGS. 8 and 9).

If the UE provides the device ID (as an example of the common ID), the device ID may, depending on the case, be transferred by protocols of different levels, e.g. access level and application level. For example, when the UE provides the MEC application with the device ID, the protocol between the UE and the MEC application (MEC application entity 10) may be an application level protocol, e.g. an API between a client in the UE and a server part supported by the MEC application.

The device ID and “User's ID in LAN” pair is made available (as suggested in FIG. 9, steps 908, 910) to the MEC application (MEC application entity 10) that handles the routing-by-private-identities feature in a MEC server (or servers) 73 related to the LAN. In this case, the MEC application may be regarded as untrusted to the mobile operator, and trusted to the LAN.

According to exemplary embodiments of the present invention, when the UE 71 attaches to a mobile network 74 (before or after registering the device ID to the LAN) which has MEC servers 73, a core network entity that can access the information of the typically ciphered signaling gets information like user identity (IMSI) and device identity (IMEI), location (e.g. cell-ID), and later during the signaling exchange the IP address allocated to the UE.

In current 3GPP networks, this core network entity may be e.g. MME 74a. MME 74a is used in the following as an example, and the present invention is not limited to an MME 74a embodying such core network entity.

According to further exemplary embodiments, optionally, the network entity (e.g. MME 74a) may make an enquiry to a subscription database (e.g. Home Subscriber Server (HSS)/user data repository (UDR)) for a subscription profile/information and check from the so acquired subscription profile/information whether the user is allowed to use the routing-by-private-identities feature.

Further optionally, the subscription profile may contain the private realm or realms the subscriber's traffic is entitled to be routed to. The network entity (e.g. MME 74a) may use the information to determine whether the MEC server 73 the UE 71 is connected to (via the current eNB 72) is connected to any of the realms allowed to the user, and consequently, whether IP address binding information should be sent to the MEC server.

If allowed to the user, or if checking/control is not applied, the network entity 74a delivers the device ID/IMEI, the IP address allocated to the UE, and a mobile network specific user identity (e.g. IMSI) to be available to the ME platform 73b (of the MEC server 73 connected to the eNB 72 the UE 71 is connected to). The network entity 74a may deliver the parameters either directly to the MEC platform (entity) 73b or to/via a common storage area or third party.

According to exemplary embodiments of the present invention, provisioning of the information may be implemented in different ways/mechanisms, e.g. using/applying a shared data layer (SDL), defining a simple control protocol/API between the network entity 74a and MEC server 73 and sending the parameters directly to the ME platform 73b, or applying service capability exposure function (SCEF) the MEC server 73 being the external party to get access to the information.

If the mobile network specific user identity/IMSI and a device ID/IMEI already exist in the common storage area or in ME platform 73b, when a new set is received, according to exemplary embodiments of the present invention, ME platform 73b adds the IP address to the data record, but does not have to add the device ID/IMEI (unless it differs from the existing device ID/IMEI and there is a request to replace the existing device ID/IMEI with the new one). In other words, according to exemplary embodiments of the present invention, only one device ID per subscriber needs to be registered in both networks (i.e. in the LAN 75 and in the MEC platform 73b or common storage area in the mobile network 74), and after that the user may use the routing-by-private-identities feature with any other device. The once registered (device) ID acts as a key between the User's LAN IDs and mobile network ID, the key being known by both networks.

When the MEC application (entity) 10 requests the ME platform to register a new private identity/token (in line with the ETSI MEC UE Identity API work item), according to exemplary embodiments of the present invention, the request may contain (at least) the device ID of the user's device registered earlier in the private/enterprise network 75 and the new private identity/token.

The request may originate e.g. from the private/enterprise network/LAN or from the user/UE via the MEC application (entity) 10 (as suggested in FIG. 8, steps 810, 811). The way of communication between the UE 71 and the MEC application 10 or between the private/enterprise network/LAN and the MEC application may, according to exemplary embodiments of the present invention, be e.g. application level client/server signaling.

When the ME platform 73b receives the request to register a new private identity/token for actions, the ME platform 73b uses the device ID as a key to fetch the IP address of the UE bound to the key. According to exemplary embodiments of the present invention, this fetching may be an internal operation at the ME platform 73b. Alternatively, this may be a fetch from a common storage area. The implementation depends, among others, on whether the network entity 74a delivered the parameters to the ME platform 73b or to/via a common storage area.

According to exemplary embodiments of the present invention, the ME platform 73b uses the IP address of the UE, the private identity/token (or identities/tokens) and possible further information to create a routing rule (or rules) and sends the rule(s) to the data/forwarding plane 73c. The data/forwarding plane 73c then routes the detected traffic, i.e. traffic to/from the IP address of the UE and further identified by the private identity/token, according to the rules, e.g. to the private/enterprise network 75 (or other destination defined by the routing rule(s)).

According to further exemplary embodiments of the present invention, the context of the mobile network specific user identity/IMSI and the device ID/IMEI is maintained by the ME platform 73b and/or common storage area as long as a there is no request to remove or replace the information. A request to remove or replace the information may originate e.g. from the private/enterprise network/LAN 75 or the MEC application entity 10 or the core network 74. According to further exemplary embodiments of the present invention, the lifetime of the information is timer controlled, that is, maintenance of the context of the mobile network specific user identity/IMSI and the device ID/IMEI may be ceased upon expiry of a timer corresponding to the lifetime.

In order to avoid incorrect operations due to invalid IP addresses and/or missing information, according to still further exemplary embodiments of the present invention, the IP address of the UE and the related routing rules is invalidated/nullified at the “old” MEC server 73, when the UE 71 makes a handover to another MEC server. If the IP address and the related user/UE identity information is not in a common storage area like SDL, the information may be moved to the new MEC server/ME platform during the handover procedure.

In order to further avoid incorrect operations due to invalid IP addresses and/or missing information, according to still further exemplary embodiments of the present invention, network entity/MME 74a may inform the relevant MEC server 73 about the event and/or may request the MEC server 73 and/or SDL to invalidate/nullify the IP address, and possibly other parameters, of the UE, when the UE detaches from the network. In such case, the MEC server may also invalidate/nullify the related routing rules.

According to still further embodiments of the present invention, the device ID (as an example for the common ID) is replaced with any other ID globally unique or unique within both networks/realms. In particular, each ID can be used as the common ID as long as it can be delivered to both networks and bound in each network with a network specific user ID.

In such way, according to the present invention, the common ID can be used as a key/link to bind the network specific IDs, and consequently, point to the same subscriber and information.

For current access level protocols, usage of a device ID is preferable due to support capabilities by these current access level protocols. However, next generation protocols may be more flexible, and corresponding application level protocols may support the transmission of any parameters, such that usage of arbitrary IDs as the common ID is encouraged.

According to still further exemplary embodiments of the present invention, instead of a common ID for a device a common ID for a subscriber is configured/used in both networks/domains. The use of such ID is similar to the above-discussed exemplary embodiments. Such embodiments provide the advantages that such approach is free from possible limitations caused by the UE and/or protocols used between the UE and networks/domains. However, the ID would have to be configured for each subscriber, and an impact on different network entities is expected by such approach.

Exemplary embodiments of the present invention are now described with reference to FIGS. 8 and 9. In particular, FIG. 8 depicts an embodiment according to which the device ID/IMEI is configured for each subscriber in the private/enterprise network/LAN. Further, FIG. 9 depicts an embodiment according to which the device ID/IMEI is sent by the UE directly to the MEC application (as suggested in FIG. 9, step 908 (i.e. alternative 1)) or via the private/enterprise network/LAN (as suggested in FIG. 9, steps 909 and 910 (i.e. alternative 2)).

In detail, in FIG. 8, the system environment comprises of a UE, a MEC application (entity), a ME platform (entity), a MME, a HSS/UDR, and a P/E-LAN.

In step S801 of FIG. 8, a device ID per user is configured in LAN.

Further, in step S802, a request is transmitted from the P/E-LAN to the MEC application. The request may comprise the device ID/IMEI and the User's ID in LAN (“Request: [Device ID/IMEI, User's ID in LAN]”).

In step S803, an attach request is transmitted from the UE to the MME. The attach request may comprise the IMSI, the device ID/IMEI, and further parameters (“Attach Request [IMSI, device ID/IMEI, Params]”). In step S804, a request comprising parameters may be forwarded from the MME to the HSS/UDR (“Request [Params]”). Further, in step S805, a response including a subscription profile is transmitted from the HSS/UDR to the MME (“Response [Subscription profile]”). Finally, in step S806, a response is transmitted from the MME to the UE.

In step S807, a) the MME checks the subscription profile, b) the MME gets the IP address allocated to the UE, and c) the MME prepares to send information to the ME platform. This information may be provided to the ME platform either directly (see steps S808 and S809) or via e.g. a common storage area (see step S814 a)).

In step S808, MME transmits a message to the ME platform. The message may include the device ID/IMEI, UE's IP address, and the IMSI (“Message: [Device ID/IMEI, UE IP Addr, IMSI]”). In step S809, the ME platform, upon receipt, stores the parameters of step S808.

In step S810, the UE transmits a trigger to the MEC application. The trigger includes the User's ID in LAN (or alternatively the device ID/IMEI), and the private ID(s)/token(s) (“Trigger: [User's ID in LAN (or device ID/IMEI), private ID(s)/token(s)]”). If the trigger of step S810 comprises the User's ID in LAN, the user may use any other device than in earlier steps.

Alternatively to step S810, in step S811, the P/E-LAN transmits a trigger to the MEC application. The trigger includes the device ID/IMEI and the private ID(s)/token(s) (“Trigger: [device ID/IMEI(s), private ID(s)/token(s)]”).

Accordingly, in step S812, the MEC application is triggered to register a new private ID/token to the ME platform. Correspondingly, in step S813, the MEC application transmits a request to the ME platform. The request comprises the device ID/IMEI and the private ID(s)/token(s) (“Request [device ID/IMEI, private ID(s)/token(s)]”).

In step S814, the ME Platform a) fetches (either internally or from a common storage area) the IP address of the UE using the received device ID/IMEI as a key, b) creates routing rule(s) using the fetched IP address, received private ID(s)/Token(s) and possibly other parameters, and c) sends the routing rule(s) to the data/forwarding plane of the MEC server.

Just like in FIG. 8, the system environment in FIG. 9 comprises of a UE, a MEC application (entity), a ME platform (entity), a MME, a HSS/UDR, and a P/E-LAN.

In step S901, the UE transmits an attach request to the MME. The attach request includes the IMSI, device ID/IMEI, and further parameters (“Attach Request [IMSI, device ID/IMEI, Params]”). In step S902, a request comprising parameters may be forwarded from the MME to the HSS/UDR (“Request [Params]”). Further, in step S903, a response including a subscription profile is transmitted from the HSS/UDR to the MME (“Response [Subscription profile]”). Finally, in step S904, a response is transmitted from the MME to the UE.

In step S905, the MME a) checks the subscription profile, b) gets the IP address allocated to the UE, and c) prepares to send information to the ME platform. This information may be provided to the ME platform either directly (see steps S906 and S907) or via e.g. a common storage area (see step S915a)).

In step S906, the MME transmits a message including the device ID/IMEI, the UE's IP address, and the IMSI to the ME platform (“Message: [device ID/IMEI, UE IP Addr, IMSI]”). In step S907, upon receipt, the ME platform stores the parameters of step S906.

In step S908 (which is an alternative 1), the UE transmits a request to the MEC application. The request comprises the device ID/IMEI, and the User's ID in LAN (“Request [device ID/IMEI, User's ID in LAN]”).

Alternatively, in step S909 (which is thus an alternative 2), the UE transmits a request to the P/E-LAN. The request comprises the device ID/IMEI, and the User's ID in LAN (“Request [device ID/IMEI, User's ID in LAN]”). In response thereto, in step S910, the P/E-LAN transmits a request to the MEC application. The request comprises the device ID/IMEI, and the User's ID in LAN (“Request [device ID/IMEI, User's ID in LAN]”).

In step S911, the UE transmits a trigger to the MEC application. The trigger includes the User's ID in LAN (or alternatively the device ID/IMEI), and the private ID(s)/token(s) (“Trigger: [User's ID in LAN (or device ID/IMEI), private ID(s)/token(s)]”). If the trigger of step S911 comprises the User's ID in LAN, the user may use any other device than in earlier steps.

Alternatively to step S911, in step S912, the P/E-LAN transmits a trigger to the MEC application. The trigger includes the device ID/IMEI or the User's ID in LAN, and the private ID(s)/token(s) (“Trigger: [device ID/IMEI or User's ID in LAN, private ID(s)/token(s)]”).

Accordingly, in step S913, the MEC application is triggered to register a new private ID/token to the ME platform. Correspondingly, in step S914, the MEC application transmits a request to the ME platform. The request comprises the device ID/IMEI and the private ID(s)/token(s) (“Request [device ID/IMEI, private ID(s)/token(s)]”).

In step S915, the ME platform a) fetches (either internally or from a common storage area) the IP address of the UE using the received device ID/IMEI as a key, b) creates routing rule(s) using the fetched IP address, the received private ID(s)/Token(s) and possibly other parameters, and c) sends the routing rule(s) to the data/forwarding plane of the MEC server.

The above-described procedures and functions may be implemented by respective functional elements, processors, or the like, as described below.

Further, according to exemplary embodiments of the present invention, the apparatuses, network nodes, units, entities and means (in particular the apparatuses/network nodes 10 and 30 and mentioned core network entities) may be implemented as respective virtualized network functions (VNF) and/or virtualized network function components (VNFC) in a network functions virtualization infrastructure (NFVI).

Network functions virtualization (NFV) is a network architecture concept that uses technologies of information technology virtualization to virtualize entire classes of network node functions into building blocks that may connect, or chain together, to create communication services.

A VNF may consist of one or more virtual machines running different software and processes, on top of high-volume servers, switches and storage devices, or even cloud computing infrastructure, instead of having custom hardware appliances for each network function. A VNFC is an internal component of a VNF providing a defined sub-set of that VNF's functionality.

An NFVI is a totality of all hardware and software components which build up the environment in which VNFs are deployed. The NFVI can span across several locations. The network providing connectivity between these locations is regarded to be part of the NFVI.

In the foregoing exemplary description of the network entity, only the units that are relevant for understanding the principles of the invention have been described using functional blocks. The network entity may comprise further units that are necessary for its respective operation. However, a description of these units is omitted in this specification. The arrangement of the functional blocks of the devices is not construed to limit the invention, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

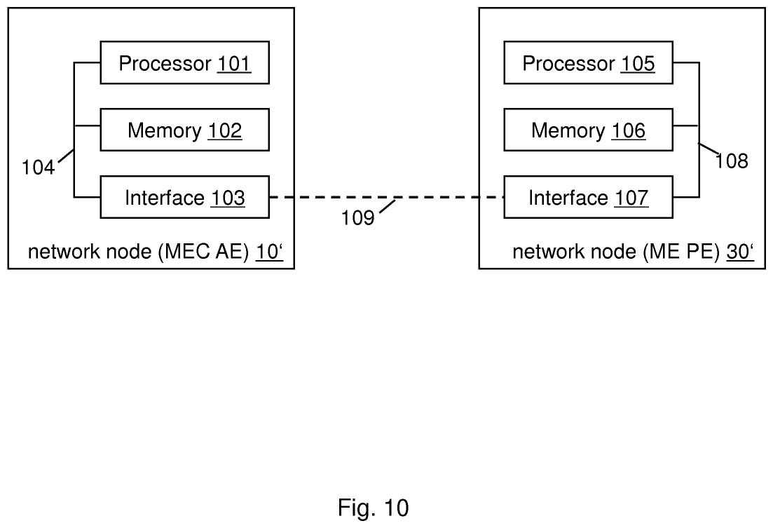

In FIG. 10, an alternative illustration of apparatuses according to exemplary embodiments of the present invention is depicted. As indicated in FIG. 10, according to exemplary embodiments of the present invention, the apparatus (network node) 10′ (corresponding to the network node 10) comprises a processor 101, a memory 102 and an interface 103, which are connected by a bus 104 or the like. Further, according to exemplary embodiments of the present invention, the apparatus (network node) 30′ (corresponding to the network node 30) comprises a processor 105, a memory 106 and an interface 107, which are connected by a bus 108 or the like, and the apparatuses may be connected via link 109, respectively.

The processor 101/105 and/or the interface 103/107 may also include a modem or the like to facilitate communication over a (hardwire or wireless) link, respectively. The interface 103/107 may include a suitable transceiver coupled to one or more antennas or communication means for (hardwire or wireless) communications with the linked or connected device(s), respectively. The interface 103/107 is generally configured to communicate with at least one other apparatus, i.e. the interface thereof.

The memory 102/106 may store respective programs assumed to include program instructions or computer program code that, when executed by the respective processor, enables the respective electronic device or apparatus to operate in accordance with the exemplary embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the network node 10 (as or at a mobile edge computing application entity in a mobile edge computing server of a first network, the mobile edge computing server comprising at least said mobile edge computing application entity and a mobile edge platform entity) comprises at least one processor 101, at least one memory 102 including computer program code, and at least one interface 103 configured for communication with at least another apparatus. The processor (i.e. the at least one processor 101, with the at least one memory 102 and the computer program code) is configured to perform receiving a conjunction of a common identifier of a network communication participant and a network specific identifier of said network communication participant in a second network, wherein said common identifier is common to said first network and said second network (thus the apparatus comprising corresponding means for receiving), to perform receiving a trigger to register a token for said network communication participant, wherein said trigger comprises at least said token and one of said common identifier and said network specific identifier of said network communication participant in said second network, and to perform transmitting, to said mobile edge platform entity, a request to register said token for said network communication participant, wherein said request comprises at least said common identifier and said token (thus the apparatus comprising corresponding means for transmitting).

Further, according to exemplary embodiments of the present invention, an apparatus representing the network node 30 (as or at a mobile edge platform entity in a mobile edge computing server of a first network, the mobile edge computing server comprising at least said mobile edge platform entity and a mobile edge computing application entity) comprises at least one processor 105, at least one memory 106 including computer program code, and at least one interface 107 configured for communication with at least another apparatus. The processor (i.e. the at least one processor 105, with the at least one memory 106 and the computer program code) is configured to perform obtaining a conjunction of a common identifier of a network communication participant and a network address assigned to said network communication participant in said first network, wherein said common identifier is common to said first network and a second network (thus the apparatus comprising corresponding means for obtaining), to perform receiving, from said mobile edge computing application entity, a request to register a token for said network communication participant, wherein said request comprises at least said common identifier and said token (thus the apparatus comprising corresponding means for receiving), and to perform generating an action rule for said network communication participant on the basis of said request (thus the apparatus comprising corresponding means for generating).

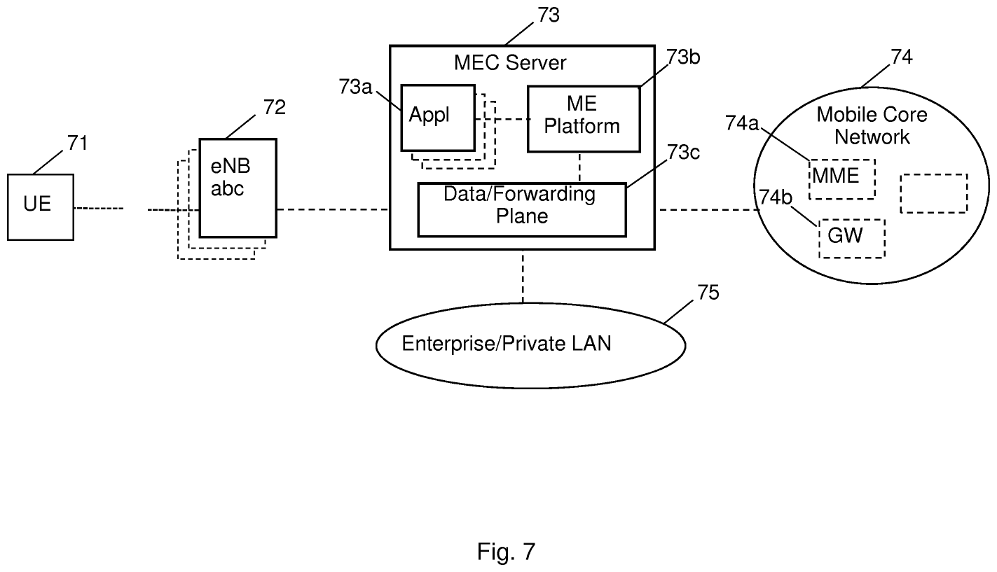

For further details regarding the operability/functionality of the individual apparatuses, reference is made to the above description in connection with any one of FIGS. 1 to 9, respectively.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity /network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for user equipment identity implementation in mobile edge scenarios. Such measures (in a mobile edge platform entity in a mobile edge computing server of a first network, the mobile edge computing server comprising at least said mobile edge platform entity and a mobile edge computing application entity) exemplarily comprise obtaining a conjunction of a common identifier of a network communication participant and a network address assigned to said network communication participant in said first network, wherein said common identifier is common to said first network and a second network, receiving, from said mobile edge computing application entity, a request to register a token for said network communication participant, wherein said request comprises at least said common identifier and said token, and generating an action rule for said network communication participant on the basis of said request.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP 3rd Generation Partnership Project

API application programming interface

CN core network

DB database

eNB evolved Node B, eNodeB

ETSI European Telecommunications Standards Institute

GW gateway

HSS Home Subscriber Server

ID identity, identifier

IMEI international mobile equipment identity

IMSI international mobile subscriber identity

IP internet protocol

ISG Industry Specification Group

LAN local area network

LTE Long term evolution

ME Mobile Edge

MEC Mobile Edge Computing

MME mobility management entity

NFV network functions virtualization

NFVI network functions virtualization infrastructure

P/E Private/enterprise

P-GW packet data network gateway

RCAF radio congestion awareness function

SCEF service capability exposure function

SDL shared data layer

UDR user data repository

UE user equipment

VNF virtualized network function

VNFC virtualized network function component

1. A method of a mobile edge computing application entity in a mobile edge computing server of a first network, the mobile edge computing server comprising at least said mobile edge computing application entity and a mobile edge platform entity, said method comprising:
receiving a conjunction of a common identifier of a network communication participant and a network specific identifier of said network communication participant in a second network, wherein said common identifier is common to said first network and said second network;
receiving a trigger to register a token for said network communication participant, wherein said trigger comprises at least said token and one of said common identifier and said network specific identifier of said network communication participant in said second network; and
transmitting, to said mobile edge platform entity, a request to register said token for said network communication participant, wherein said request comprises at least said common identifier and said token.

2. The method according to claim 1, wherein
if said trigger comprises said network specific identifier of said network communication participant in said second network, in relation to said transmitting, said method further comprises
ascertaining said common identifier based on said conjunction and said network specific identifier of said network communication participant in said second network included in said trigger.

3. The method according to claim 1, wherein
said conjunction is received from said network communication participant or a control entity of said second network,
said trigger is received from said network communication participant or said control entity of said second network.

4. The method according to claim 1, wherein
at least one of said first network and said second network is a radio network, or
said first network is one of a LTE cellular network system, a LTE-A cellular network system, and a 5G network system, or
said second network is one of a private network, an enterprise network, and a local area network, or
said network communication participant is a terminal and said common identifier is a device identifier globally unique to said terminal,
said network communication participant is a subscriber utilizing a terminal and said common identifier is a subscriber identifier globally unique to said subscriber, or
said network specific identifier of said network communication participant in said second network is a user's identity in a local area network, or
said network specific identifier of said network communication participant in said first network is an international mobile subscriber identity, or
said token is a private identity belonging to a realm of said second network.

5. A method of a mobile edge platform entity in a mobile edge computing server of a first network, the mobile edge computing server comprising at least said mobile edge platform entity and a mobile edge computing application entity, said method comprising:
obtaining a conjunction of a common identifier of a network communication participant and a network address assigned to said network communication participant in said first network, wherein said common identifier is common to said first network and a second network;
receiving, from said mobile edge computing application entity, a request to register a token for said network communication participant, wherein said request comprises at least said common identifier and said token; and
generating an action rule for said network communication participant on the basis of said request.

6. The method according to claim 5, wherein
in relation to said obtaining, said method further comprises
receiving said conjunction from a core network entity of said first network, and/or wherein
said conjunction further comprises a network specific identifier of said network communication participant in said first network.

7. The method according to claim 5, wherein
in relation to said obtaining, said method further comprises
fetching said conjunction from a storage area common with a core network entity of said first network based on said common identifier included in said request, or wherein
said conjunction further comprises a network specific identifier of said network communication participant in said first network.

8. The method according to claim 6, wherein
in relation to the obtaining, the method further comprises
checking for existence of an entry of said network specific identifier of said network communication participant in said first network according to the conjunction, and
if said entry exists, adding said network address to said existing entry.

9. The method according to claim 8, wherein
in relation to the obtaining, the method further comprises
if a common identifier included in said existing entry does not correspond to said common identifier according to the conjunction and a request to replace said common identifier included in said existing entry is received,
replacing said common identifier included in said existing entry by said common identifier according to the conjunction.

10. The method according to claim 6, further comprising
deciding necessity to remove said conjunction, and
removing, based on a result of said deciding, said conjunction from said storage area common with said core network entity or a storage area of said mobile edge platform entity, wherein
in relation to said deciding, said method further comprises
receiving a request to remove said conjunction, or
detecting expiration of a validity timer assigned to said conjunction.

11. The method according to claim 5, wherein
in relation to said generating, said method further comprises
associating said network address with said token based on said conjunction and said common identifier included in said request.

12. The method according to claim 11, wherein
said action rule for said network communication participant is generated on the basis of said association of said network address and said token.

13. The method according to claim 5, further comprising
transmitting said action rule to a rules enforcement entity of said mobile edge computing server.

14. The method according to claim 5, wherein
at least one of said first network and said second network is a radio network, or
said first network is one of a LTE cellular network system, a LTE-A cellular network system, and a 5G network system, or
said second network is one of a private network, an enterprise network, and a local area network, or
said network communication participant is a terminal and said common identifier is a device identifier globally unique to said terminal, or
said network communication participant is a subscriber utilizing a terminal and said common identifier is a subscriber identifier globally unique to said subscriber, or
said network specific identifier of said network communication participant in said second network is a user's identity in a local area network, or
said network specific identifier of said network communication participant in said first network is an international mobile subscriber identity, or
said token is a private identity belonging to a realm of said second network, and/or
said action rule is a network traffic routing rule, or
said rules enforcement entity is a data forwarding plane entity.

15. An apparatus of a mobile edge computing application entity in a mobile edge computing server of a first network, the mobile edge computing server comprising at least said mobile edge computing application entity and a mobile edge platform entity, the apparatus comprising:
at least one processor;
at least one memory including computer program code; and
at least one interface configured for communication with at least another apparatus,
the at least one processor, with the at least one memory and the computer program code, being configured to cause the apparatus to perform:
receiving a conjunction of a common identifier of a network communication participant and a network specific identifier of said network communication participant in a second network, wherein said common identifier is common to said first network and said second network,
receiving a trigger to register a token for said network communication participant, wherein said trigger comprises at least said token and one of said common identifier and said network specific identifier of said network communication participant in said second network, and
transmitting, to said mobile edge platform entity, a request to register said token for said network communication participant, wherein said request comprises at least said common identifier and said token.

16. The apparatus according to claim 15, wherein
in relation to said transmitting, the at least one processor, with the at least one memory and the computer program code, being configured to cause the apparatus to perform:
if said trigger comprises said network specific identifier of said network communication participant in said second network,
ascertaining said common identifier based on said conjunction and said network specific identifier of said network communication participant in said second network included in said trigger.

17. The apparatus according to claim 15, wherein
said conjunction is received from said network communication participant or a control entity of said second network, or
said trigger is received from said network communication participant or said control entity of said second network.

18. An apparatus of a mobile edge platform entity in a mobile edge computing server of a first network, the mobile edge computing server comprising at least said mobile edge platform entity and a mobile edge computing application entity, the apparatus comprising:
at least one processor;
at least one memory including computer program code; and
at least one interface configured for communication with at least another apparatus,
the at least one processor, with the at least one memory and the computer program code, being configured to cause the apparatus to perform:
obtaining a conjunction of a common identifier of a network communication participant and a network address assigned to said network communication participant in said first network, wherein said common identifier is common to said first network and a second network,
receiving, from said mobile edge computing application entity, a request to register a token for said network communication participant, wherein said request comprises at least said common identifier and said token, and
generating an action rule for said network communication participant on the basis of said request.

19. The apparatus according to claim 18, wherein
in relation to said obtaining, the at least one processor, with the at least one memory and the computer program code, being configured to cause the apparatus to perform:
receiving said conjunction from a core network entity of said first network, or wherein
said conjunction further comprises a network specific identifier of said network communication participant in said first network.

20. The apparatus according to claim 18, wherein
in relation to said obtaining, the at least one processor, with the at least one memory and the computer program code, being configured to cause the apparatus to perform:
fetching said conjunction from a storage area common with a core network entity of said first network based on said common identifier included in said request, or wherein
said conjunction further comprises a network specific identifier of said network communication participant in said first network.

21. The apparatus according to claim 19, wherein
in relation to the obtaining, the at least one processor, with the at least one memory and the computer program code, being configured to cause the apparatus to perform:
checking for existence of an entry of said network specific identifier of said network communication participant in said first network according to the conjunction, and
if said entry exists, adding said network address to said existing entry.

22. The apparatus according to claim 21, wherein
in relation to the obtaining, the at least one processor, with the at least one memory and the computer program code, being configured to cause the apparatus to perform:
if a common identifier included in said existing entry does not correspond to said common identifier according to the conjunction and a request to replace said common identifier included in said existing entry is received,
replacing said common identifier included in said existing entry by said common identifier according to the conjunction.

23. The apparatus according to claim 19, wherein
the at least one processor, with the at least one memory and the computer program code, being configured to cause the apparatus to perform:
deciding necessity to remove said conjunction, and
removing, based on a result of said deciding, said conjunction from said storage area common with said core network entity or a storage area of said mobile edge platform entity, wherein
in relation to said deciding, the at least one processor, with the at least one memory and the computer program code, being configured to cause the apparatus to perform:
receiving a request to remove said conjunction, or
detecting expiration of a validity timer assigned to said conjunction.

24. The apparatus according to claim 18, wherein
in relation to said generating, the at least one processor, with the at least one memory and the computer program code, being configured to cause the apparatus to perform:
associating said network address with said token based on said conjunction and said common identifier included in said request.

25. The apparatus according to claim 24, wherein
said action rule for said network communication participant is generated on the basis of said association of said network address and said token.

26. The apparatus according to claim 18, wherein
the at least one processor, with the at least one memory and the computer program code, being configured to cause the apparatus to perform:
transmitting said action rule to a rules enforcement entity of said mobile edge computing server.

27.-38. (canceled)

39. A computer program product embodied on a non-transitory computer-readable medium, said product comprising computer-executable computer program code which, when the program is run on a computer, is configured to cause the computer to carry out the method according to claim 1.

40. (canceled)
